(19) United States
(12) Patent Application Publication
(10) Pub. No.: US 2003/0018968 A1
(43) Pub. Date: Jan. 23, 2003

(54) Method and apparatus for inserting data into video stream to enhance television applications

(76) Inventor: Mark Avnet, (US)

Correspondence Address: JAMES D. FORNARI, LAW OFFICES OF JAMES D. FORNARI/VIRGIN, CAPITAL CORP, 645 MADISON AVENUE - 13TH FLOOR, NEW YORK, NY, 10022, US

(21) Appl. No.: 10/057,703

(22) Filed: Jan. 25, 2002

Related U.S. Application Data
(60) Provisional application No. 60/265,284, filed on Feb. 1, 2001.

(51) Int. Cl. H04N 7/025; H04N 7/10; H04N 7/173; G09G 5/00

(52) U.S. Cl. 725/32; 725/36; 345/723

(57) ABSTRACT

The present invention is a method and apparatus for inserting data into a video stream in conjunction with and as a part of a visual and contextual experience in a broadcast or other distribution method. Digital Donut (“Donut”) is a video application that runs on analog or digital video programming, distributed over broadcast, cable, CD, DVD, broadband and/or other distribution methods. Digital Donut provides a method and apparatus for taking non-video-originated (NVO) content and repackaging it for transmission in a broadcast or streamed medium (Primary Content). The Digital Donut may be comprised of elements that permit the repackaging of the NVO data into the broadcast feed. The users of the system will be able to employ it for marketing, commercial or other content enhancement, often making changes on the fly which will permit up-to-date data to be transmitted in a time related manner that is directly relevant to the program or Primary Content.

Internet content but in which each user is browsing independently, and in which the Internet content is delivered in a separate stream from the broadcast content.

The Digital Donut permits the merging of NVO content with a broadcast feed for viewing on a standard receiver or display unit without the use of other appliances. The Digital Donut permits the NVO content to be created locally or distally, repackaged locally or distally relative to the creation, insertion or distribution points, and/or distributed locally or distally relative to the creation, repackaging or transmission points. Furthermore, the Digital Donut permits the NVO content to be contextually related to the video stream into which it is inserted or be unrelated. The Digital Donut also permits the NVO to be related to the intended recipient of the Donut package in that it may be targeted to the proposed viewer using any of the variety of demographic, psychographic, geographic and other selective targeting methods available for TV, broadcast, Internet or other media.

The Digital Donut may have varying levels of persistence or insistence. In different deployments, the content creator, the broadcaster, the cable company, the owner of the content into which the NVO content is being inserted, the viewer, and/or other intermediaries, including artificial intelligence engines and control from advanced set-top boxes, gaming stations and computers, may control NVO content insertion and/or its ability to be viewed.

### RELATED APPLICATIONS

This is an application which is based upon and is part of a provisional application entitled DIGITAL DONUT, Serial No. 60/265,284 filed Feb. 1, 2001.

### BACKGROUND OF THE INVENTION

The broadcast television industry is in a period of transition. Both networks and local stations are grappling with the Internet and trying to determine the best strategies to compete effectively in the future. Broadcasters are facing change on multiple fronts: new forms of programming, new advertising and business models, new audience expectations, and new competitive forces that are eroding their audience base and diminishing advertising revenues. The current landscape is the result of government regulations, economic demands, and the increasing influence of new technologies.

Broadcast is failing to take advantage of new business opportunities created by the Internet. The business model for the broadcast industry is advertiser-supported, which puts broadcasters in the business of producing audiences, not programming. With advertising as its main source of revenue, the broadcast television industry has been experimenting with Internet strategies and learning from Internet business models. In the case of networks, they have entered partnerships with online sites that have allowed them co-branding and promotion opportunities. In the case of local stations, their strategies are as various as their markets, but in general they are not realizing the full potential of the Internet. In a recent survey, most stations did not report having full-time staff working on their web sites, and a mere 5% reported having advertising banners that tied to on-air advertising. Clearly, local stations need to focus more on Internet strategies and the opportunities they offer for growing their business.

Broadcasters compete with cable for audience and, to a lesser degree, for advertising. Since cable is subsidized by subscription revenue, it can focus on niche programming that carves off segments of the potential broadcast audience. Cable TV's strategy is to develop vertical or affinity programming—highly targeted to specific demographics and interest. While cable television also sells advertising, its audience for individual channels is tiny and the marketing effort less intense due to the steady stream of revenue from subscription fees. The future doesn't look promising for broadcasters, either—according to a recent Myers Group survey, nearly 70% of respondents believe that cable operators will reap the greatest benefits from interactive television—not great news for an industry struggling to understand the Internet.

The broadcast industry is really two types of businesses: 1) the networks and 2) the local stations. The major networks seem to get all the attention, even though they only account for about a third of the advertising revenue spent on TV. Each of the three major networks has 200 or more affiliates, with Fox and the others not far behind. Despite the fact that they inhabit the same economic ecosystem, relations between networks and local stations are full of conflict. According to Jupiter, “Broadcast networks have generally done a poor job supporting local affiliates and spurring interest in daily programming.” Jupiter believes that networks have abandoned their local TV affiliates online, and are themselves struggling with the challenges created by the Internet.

Interactive television is on everyone's mind, but it's not here yet. According to Jupiter, iTV will reach 27 percent of U.S. households—nearly 20 million households—by 2004. Despite this rosy outlook, most players are still in the early stages of iTV deployment, and iTV services probably won't reach critical mass for at least 3 or 4 years, according to most reports.

Beyond the specific challenges from the Internet and cable, the broadcast industry is trying to position itself for the future. A host of market dynamics are driving the industry, including economic and technology trends that are forcing broadcasters to refine their business models and address critical infrastructure needs: Locally targeted advertising will grow substantially. Jupiter forecasts that the market for locally targeted online advertising will grow from about $500 million in 1999 to just under $3 billion in 2003. In addition, the market for local TV spot advertising is forecast to become the largest source of revenue for the broadcast industry this year. The opportunity to form partnerships with local content players is a viable strategy. With their promotion capabilities, TV stations can strike deals that allow them to leverage their broadcasting assets and enhances their profile in their local market.

Digital TV has been full of delays and problems. In 1996, the FCC approved legislation that gave television broadcasters a digital signal to use alongside their analog channels during the transition period from analog to digital (in 2006, all analog channels will be shut down and auctioned off). Both the government and broadcast industry assumed that consumers would buy expensive digital TV sets because of the expanded services they offered. Unfortunately, that has not been the case—in fact, only about 230,000 digital televisions have been sold in the U.S. In addition, local stations have exploited use of the digital channel by entering into the datacasting business and partnering with content distributors such as iCast.com and Internet Broadcasting Systems.

TV stations are looking at Internet opportunities as a possible move away from the traditional network/affiliate model. This would create a huge paradigm shift. Some people believe that local stations can win a piece of the huge Internet advertising pie if they invest the people and resources into their web ventures. However, current revenue models still view web sites and TV ads as separate entities. Even in the case of integrated packages, a media buyer may purchase a TV spot and ad banners/sponsorship on the local station web site, but there's no attempt to merge the two mediums. As reported earlier, only 5% of stations reported having advertising banners that tied to on-air advertising.

Advertising is the engine that drives the economy of the television industry. Advertising accounts for more than 90% of a typical station's revenue, with the remainder coming in the form of network compensation paid to a station for carrying network programming. There are three types of TV advertising sales: network sales, national spots, and local spots.

Advertisers can purchase advertising on the networks to reach a national audience. This blankets the entire country with the same ad and gives reach while sacrificing the ability to target individual markets separately. Advertisers can also buy advertising via only those stations that reach a specific geographic or demographic market. While it's less expensive to buy spots on the network, it's more efficient to purchase advertising on a small number of stations in specified markets, if that's the goal. It also helps an advertiser adjust their media planning and buying to address specific marketing needs.

Local spots are purchased via individual stations. In the case of local advertising, merchants deal directly with the stations to purchase spots that will be seen only on that station. This is the way a station derives most of its revenue, and local stations position themselves to both national and local advertisers as experts on the local marketplace.

Interactive video and audio systems are currently being introduced into the entertainment and educational industries. A prominent interactive technology that has been applied successfully in these industries is based on providing interactivity in a one way system through the use of multiple parallel channels of information. For example, commonly owned Freeman et al. patents, U.S. Pat. Nos. 4,264,925 and 4,264.924, which provide both audio and video interactivity, disclose interactive television systems where switching among multiple broadcast or cable channels based on viewer selections provides an interactive capability.

These systems have been enhanced to include memory functions using computer logic and memory, where selection of system responses played to the viewer are based on the storage and processing of subscriber responses, as disclosed in Freeman patent, U.S. Pat. No. 4,507,680.

The benefits of providing interactivity through the use of different audio responses is disclosed in Freeman, U.S. Pat. Nos. 4,847,698, 4,847,699 and 4,847,700. These television systems provide a common video signal accompanied by several synchronized audio channels to provide content related user selectable responses. The audio signals produce different audio responses, and in some cases, these are syllable synched to a first audio script and to the video signal (such as to a person or character on a display), providing the perception that the person's or character's mouth movements match the spoken words. However, this does not easily permit the insertion of data into the video stream to take advantage of the merging, in real time, of video and non-video data as is provided by the current invention.

Interactivity is brought into the classroom in other Freeman U.S. Patents where an instructor, either broadcast live on video or displayed from video tape, asks a question, and each and every student responds, preferably by entering a response on a remote handset, and each student immediately receives a distinct and substantive audio response to his or her unique selelction.

Similarly, individualization of audio is brought to the home based on the technology disclosed in other Freeman U.S. patents. These systems provides a program that can be watched on any conventional television set or multimedia computer as a normal program. But if the viewer has a special interactive program box connected to the television, he or she can experience a fully functional interactive program. Each interactive viewer can personalize the audio response and video graphics overlaid on the screen. The interactive program can be provide to television sets or to computers by cable, direct broadcast satellite, television broadcast or other transmission means and can be analog or digital. However, this type of system, much like those discussed above, introduces responses to the viewer through the use of “trigger points” used throughout the program or which occur at different point on the screen. These can occur at designated times or at designated points which thus trigger a preset response when the user clicks on a button. However, all of the above systems preset the audio and only permit the user to select among a variety of pre-chosen audio contexts.

What is needed is personalization provided via a television enhancement means which permits a real time, seamlessly integrated audio/visual experience that is evolving and providing additional information, entertainment and data to the particular user. While the ultimate goal for every advertiser is to generate greater sales, local retailers would pay more for station-generated advertising/marketing packages if the commercials would do more to move products off the store shelves. For example, for a car dealer whose prospects live within five miles of his dealership television advertising is too expensive for him. The Digital Donut can help TV improve its value to advertisers by making TV competitive with other media, such as radio and newspapers, not to mention cable and the Internet.

### SUMMARY OF THE INVENTION

Digital Donut is a method and apparatus for embodying a rich audio/visual experience in a television programming application and for permitting advertisers or other parties to personalize that experience by the insertion of data, both of a video and non-video nature, in real time, into the video stream.

Just-In-Time Video-Editing (JITVE), a.k.a. Digital Donut, is the method of merging, in real-time, video and non-video data in a video stream. The process of inserting content into an broadcast can employ equipment and technologies that exist in the majority of television control rooms. Character generators (CGs) already exist in controls rooms. Internet content and other data can be transferred to the CG via a physical connection (serial cable) or network (FTP, Telnet, etc.). The process of pulling data from other sources, including the Internet, can be automated by the CG working in conjunction with Intelligent Interface software include in the CG, an add-on Intelligent Interface software module, or a custom software solution.

Content can be displayed on television within pre-designed templates created by the CG or imported from a graphics suite. Templates can be branded by the advertiser and customized to match the graphical look and feel of the commercial. Depending upon the CG, sophisticated sound and animation can be incorporated into template.

CG hardware and software used in television broadcast systems is expensive to replace; the same model CG is often used for many years. Digital Donut may be adapted to work with legacy CG systems. Current CG systems often do not easily support Web-friendly graphics. This invention contemplates the additional step of automatically converting Web graphics (GIF, JPEG, etc.) to these formats before they are imported to the CG.

In some cases, depending upon the CG and other hardware in use, additional software may be required to enable Digital Donut. Several vendors, including Broadcast Software Solutions and Video Design Software produce off-the-shelf and custom middleware that facilitate the Internet to CG data transfer.

Software add-ons compatible with specific brands and models of CG can make the automated importation of data into the CGs more convenient, as well as display richer graphics more easily.

Most next-generation CGs are PC/NT-based and have a greater flexibility in terms of the types of data they are able to import. Although PC/NT-based CG systems would make the Digital Donut easier to implement and the broadcast industry is clearly moving in the PC/NT-based direction, these systems currently make up only a small percentage of CGs in use today. The various CG makes, models, software, and software add-ons in use result in a wide range of CG capabilities. There is no standard CG capability across all local broadcast networks. In accordance with the spirit and scope of the invention, the Digital Donut technical specifications can be made on a case-by-case basis at the local control room level.

The CG-lntelligent Interface scenario is currently the most inexpensive and convenient for broadcasters to implement because, for the most part, it relies on technology that already exists in the control room and that are familiar to control room operators.

### DESCRIPTION OF THE DRAWINGS

FIG. 1 is a flow chart and block diagram of a real-time insertion of data into the video stream in accordance with the present invention.

FIG. 2 is a block diagram of an exemplar timeline of graphic, audio, text and other content and their interaction to enhance the Primary Content in accordance with the present invention.

FIG. 3 is an exemplar of the use of the Digital Donut creation tool in accordance with the present invention.

FIG. 4 is a flow chart and block diagram of a Digital Donut insertion and distribution path description to provide an overview of the real-time insertion of data into the video stream in accordance with the present invention.

FIG. 5 is a flow chart and block diagram of a Digital Donut insertion and distribution path description after a satellite or other Primary Content distribution in accordance with the present invention.

FIG. 6 is a flow chart and block diagram of a Digital Donut insertion and distribution path description prior to satellite or other Primary Content distribution in accordance with the present invention.

FIG. 7 is flow chart and block diagram of an overall system in accordance with the present invention.

FIG. 8 is a flow chart and block diagram of the overall process flow for a system in accordance with the present invention.

### DETAILED DESCRIPTION OF A PREFERRED EMBODIMENT

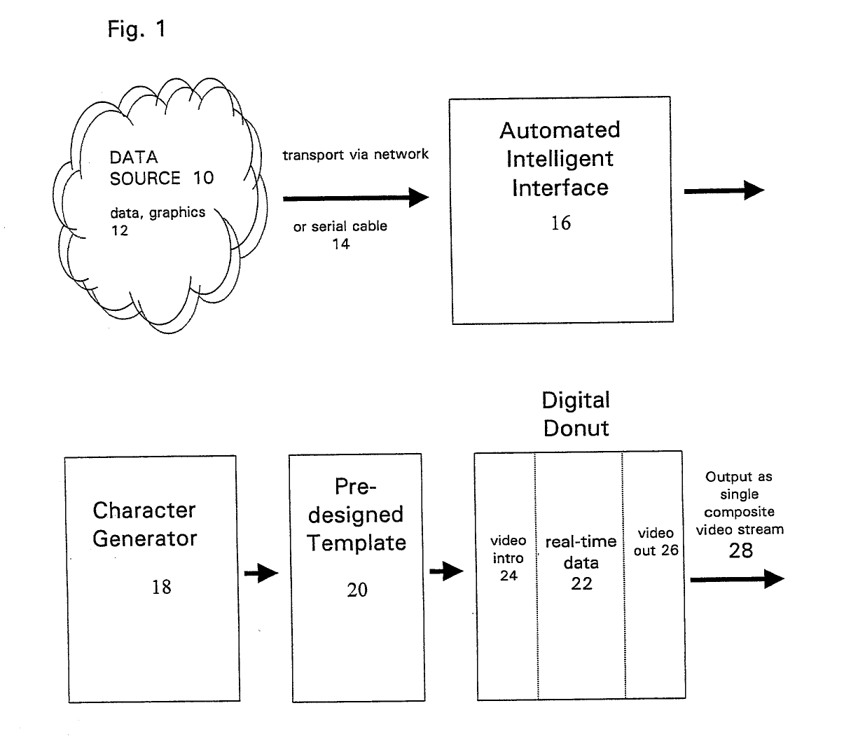

The present invention is described with reference to the enclosed Figures wherein the same numbers are utilized where applicable. Referring to FIG. 1, in a broadest embodiment employing the Internet, as an example only, to provide an inserted data source, the present invention is directed to a system having informational, educational, advertising and other commentary, of either a commercial or non-commercial nature, by merging, in real-time, video and non-video data into the video stream. The Digital Donut is a video program with a hole in it—local information or other data is the filling inserted into the hole just prior to broadcast, in either an analog or digital video format, as required. An Internet data source 10 is used to provide content 12, such as data, graphics, etc. The content 12 is transferred by a connection 14, such as a serial cable or via a network (FTP, Telnet, etc.) to an automated intelligent interface 16 which is integrated with a character generator 18. The character generator 18 pulls data from the Internet via intelligent interface software included with the character generator 18, such as those made by Chryon, or can pull the data using add-on software modules or custom software solution, depending on the data and template is to be inserted into the Primary Content video stream. It is desirable to adapt the Digital Donut to function with legacy systems inasmuch as television broadcast systems are expensive to replace and character generators 18 are often used for many years. The character generator 18 fills a pre-designed template 20 with data and content from the Internet, in this instance, for insertion into the “hole” in the Donut. The template 20 may be created by the character generator 18, or may be created by external graphics programs (not shown) or in any other manner that a person skilled in the art would generally employ to create such a template 20.

The template 20 introduces real time data 22 that it generates, into the hole in a video stream 24, thus merging the two into a video output 26 which is a single composite video stream 28.

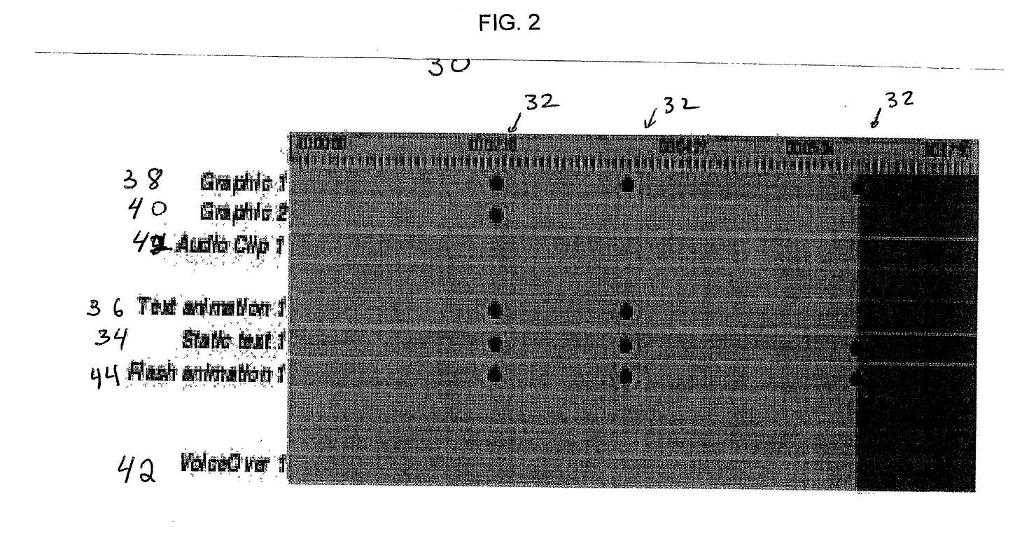

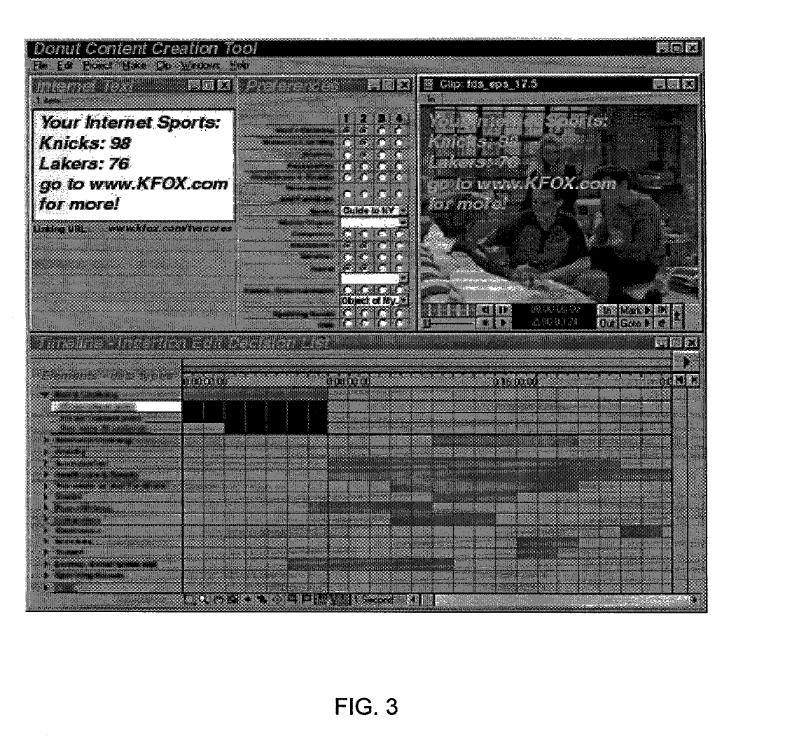

Referring to FIGS. 2 and 3, there are shown examples of non-video originated (NVO) content creation of the real time data 22. NVO content is created and edited by a timeline trigger system 30 that allows triggers 32 to be set, indicating when additional media files should be played over the video.

The NVO Content Creation system permits the following data types to be used:

Static text 34 (e.g. temperatures, sports scores, prices, quantities, descriptions, etc)

Dynamic text 36, antialiased animation-capable (e.g. updated polls, news, prices, quantities, etc)

Images 38, with or without alpha channels

Motion Graphics 40 (e.g. animation of polls, charts, graphs, etc)

Audio insertion 42 (e.g. voice-overs, music tracks, etc)

Live/near-live audio/video insertion 44 (e.g. video from weather cameras, traffic cameras, demographically/geographically targeted video inserts, ie: multiple versions of content in an advertisement delivered on demand or ala carte, etc)

Multiple layers (e.g. transparent overlays on top of background image/video: car prices on top of video of a car driving, local weather report over video from local weather cam, video inserts, simultaneous use of other data types, etc) (not shown).

Supported file formats include but are not limited to .swf, .png, gif, .jpg, tiff, .eps., .wav, .mp3, .mov., .aif file types. These various data types and file formats may be bundled into multiple or single combinations of elements, stored in a proprietary file type. This proprietary format may also include timeline and other information.

Graphic and other elements may be rendered at run-time from an edit-decision-list type of event list, or may be pre-rendered at creation time or during a batch process period.

FIG. 3 shows a sample screen 50 using the formats for the NVO content based on templates 30, which are filled in at content creation time, or may be created from scratch at that time by more sophisticated content creators. A library of templates is provided, as are the specifications for creation of new templates. The content creation tool includes the ability to reference to a timeline 52, which is based on the Primary Content, so synchronization of events may occur between the Primary Content and NVO content.

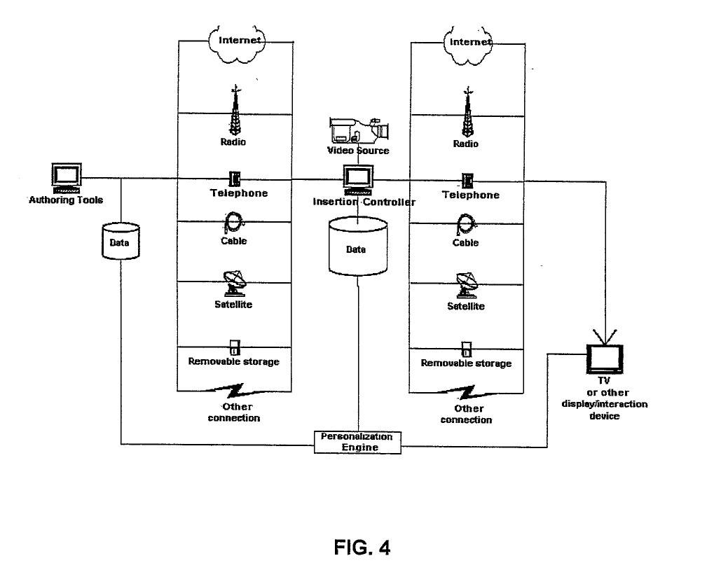

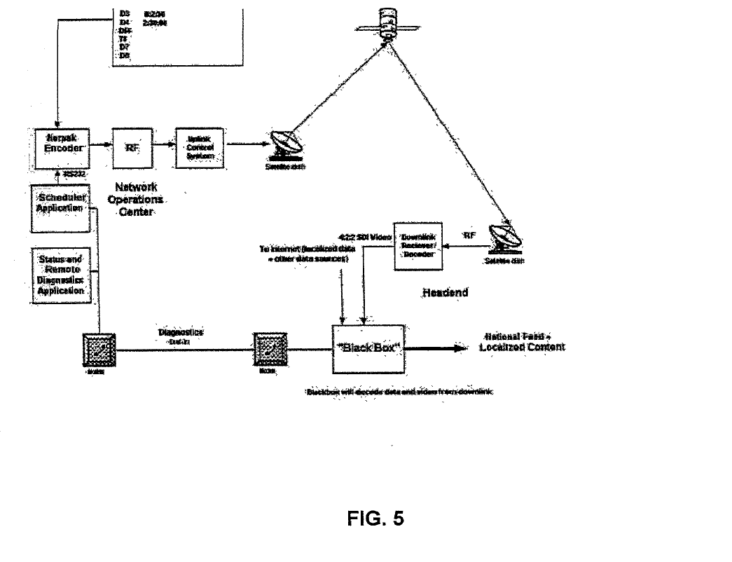

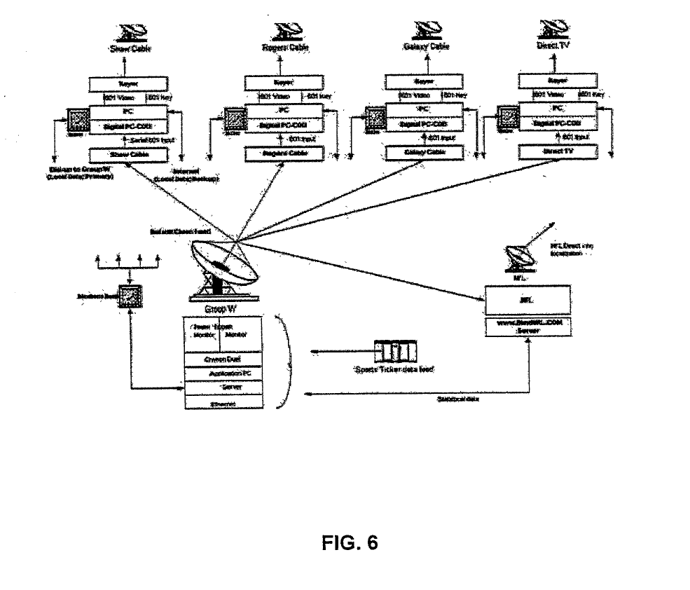

Referring to FIGS. 4, 5 and 6, there are shown various illustrative insertion and distribution modes which may be employed to effectuate the broad purposes of the present invention. Distribution cases include, but are not limited to, situations where NOV content is:

Created one-off, inserted locally

Stored in a database, inserted locally

Created one-off, distributed over network (including but not limited to Internet, private intra/extranet, wireless, and/or direct connection) for insertion

Stored in database, distributed over network (including but not limited to Internet, private intra/extranet, wireless, and/or direct connection) for insertion

Each case may be timed ad hoc (as distributed), cached locally and/or inserted at a predetermined absolute time and/or at a predetermined time relative to a marker associated with or internal to the Primary Content. Each case allows for NVO content insertion at locations including but not limited to the point of content creation, point of transmission, point of uplink, point of downlink, cable head end, set top box, game console, Web server, and/or other standard points of data manipulation and redirection.

The Donut package may be customized by use of an internal feedback and targeting system or integration with existing systems, such as 24/7 Media's Sabela product. The customization may take the form of unique graphics, animations, sound, and other forms of content which can be directed to a user or group of users depending on various categorization criteria, including but not limited to user opt-in, geographic regions, demographic or psychographic slices, and other ways of delineating individuals or groups of individuals.

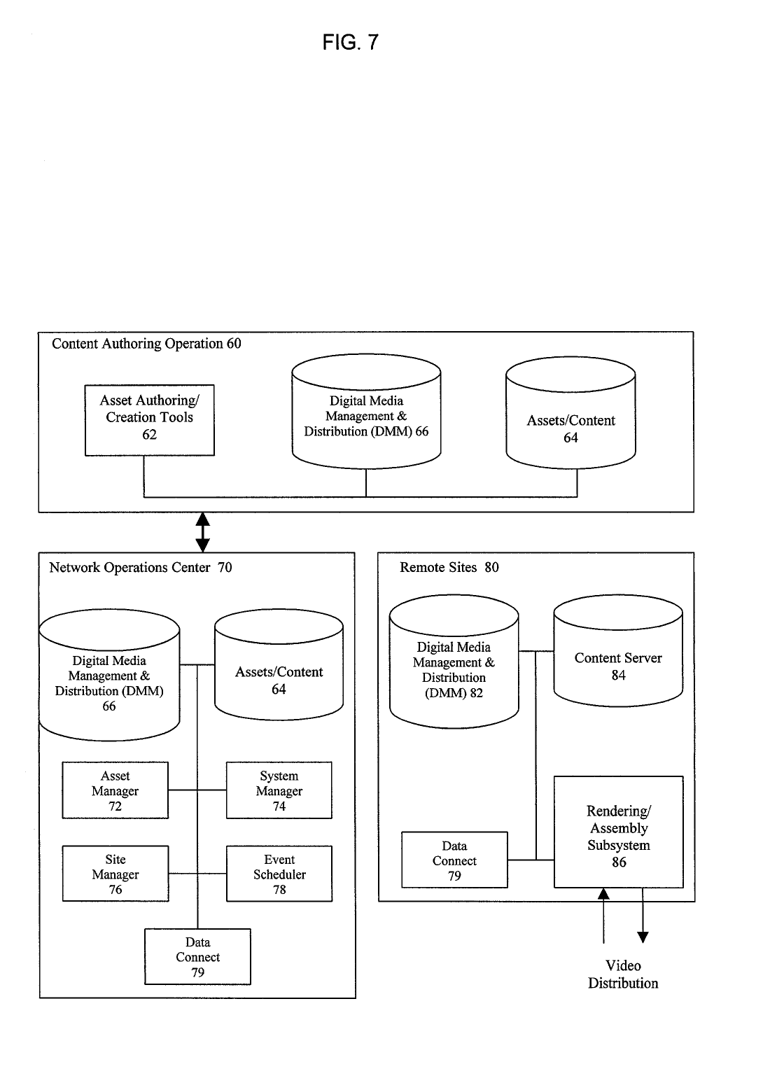

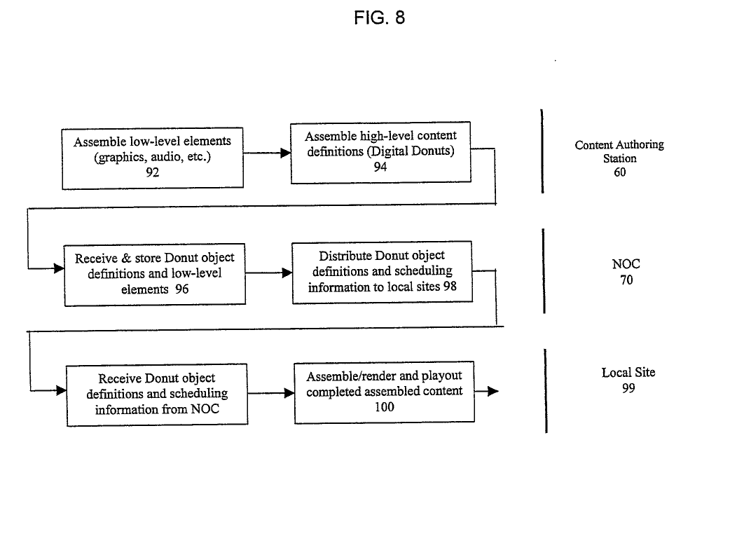

Referring to FIGS. 7 and 8, The Digital Donut is system created by merging global and locally originated sources of content and generating it off as a single, seamlessly composited video stream. This system provides a means for the distribution of information in a traditional analog or digital video format on a global basis to many locations along with the insertion of local content as required.

The Digital Donut system may be illustratively described functionally by three major subsystems:

Content Authoring Subsystem 60

Network Operations Center Subsystem 70

Localizing Subsystem 80

A top-level block diagram of the overall system is shown in FIG. 7

These subsystems are described functionally and illustratively below:

Content Authoring Subsystem

The Content Authoring subsystem 60 may be used for the authoring and pre-packaging of content (i.e. advertisements), by, for example, an agency or service bureau, in a format suitable for “just-in-time” assembly at the head-end. The Content Authoring subsystem 60 could include the following:

Custom and commercial tools for authoring 62 (e.g. Adobe Photoshop, Adobe Premier, etc.). A storage subsystem 64 for storing low-level/component elements (e.g. backgrounds, Flash animations, audio clips, etc.), as well as higher-level objects (e.g. “donut” definitions). A Digital Media Management & Distribution system 66 for management and tracking of assets.

Network Operations Center (NOC) Subsystem

The Network Operations Center subsystem 70 would, in the illustrative example, be the central control point for the system, and could provide the following functions: Storage means 64 for the advertisement (i.e. digital donut filling) and definitions for deployment to head-ends. The NOC should also include a tracking module 72 to track the digital assets and metadata. An overall system management, site configuration management and administration module 74 controls the management of the donut and its incorporation into the video stream. A head-end site management module 76 controls the actual time and data management. A scheduling of advertisement play out module 78 relates the donut to the show, while the connection to all head-end sites via a connect module 79.

Head-End Subsystem

The Head End subsystem 80 would provide for localized, just-in-time assembly of completed advertisements based on object definitions and schedules transmitted to the head-end from the NOC via the connect module 79. The Head End subsystem 80 could illustratively consist of the following components:

A Digital Media Management & Distribution (DMM) system 82 which manages and tracks the assets. A local content server 84 operates in conjunction with the DMM system 82 for short-term storage of component elements (e.g. video clips, audio clips, pre-rendered graphics, just-in-time rendered graphics, etc.). A Rendering/Assembly subsystem 84 is employed for the final rendering and assembly of advertisements for play out to the broadcast or air. The Rendering/Assembly subsystem 84 would provide the following functions, by way of example:

Retrieval of current data as required via the Internet (e.g. auction prices, inventory levels, product shots, etc.).

Just-in-time rendering of any 2D/3D graphics based on the data retrieved (e.g. Flash animations, video clip splicing, etc.).

Just-in-time rendering of any audio elements based on the data retrieved.

Final assembly of completed advertisements, including traditional text rendering and image display (i.e. character generation) functions.

Play out of completed advertisements to air under automation control.

FIG. 8 illustrates the process flow for the implementation of one preferred embodiment of the Digital Donut invention. The content authoring operation 60 assembles both low-level elements 92, which include graphics, audio and other inserts from various assets. It creates, or has given to it by others, high-level content definitions 94 which will result in the creation of the filling for the Digital Donut. The high-level definitions 94, may be comprised of an assembly of the low-level elements 92, as well as other definitions to create the overall “filling”. It is appreciated that the Content Authoring Station 60 may be resident at the NOC, or may be distal. The actual authoring may be done by an advertising agency, a service bureau, a client of the Network, or the network itself, by way of illustration only.

The content is then delivered to the NOC 70 where it is stored 96 for use in accordance with one of the aspects of the Digital Donut invention. When a Donut is called for, the NOC 70 distributes 98 the Digital Donut object definitions and scheduling information to a local site 99 where it is assembled into the merged stream. It is to be appreciated that, depending on the distribution method, the merger can take place at the NOC, or at such other location as determined by the users of the Digital Donut concept. Referring again to the illustrative process flow of FIG. 8, the local site assembles 100 and plays out the completed assembled content.

The various categories of use of the Digital Donut include, but are not limited to, its use as an Advertising/Marketing tool, as an Entertainment/information tool, as an Education tool, as a Communication tool, as part of an Advertising network, as part of the Advertising Mix and Content Mix offered by TV, Broadcast, Cable and other stations, networks, and content distribution channels, etc. It is intended that this invention cover situations where the offer to use the Donut may be made by any of the parties in the content creation, distribution, advertising, marketing, or network chain, and where the creation and/or insertion of the NOV content may be performed by any of the parties in the content creation, distribution, advertising, marketing, or network chain.

The Example Applications for Digital Donut include, but are not limited to:

TV advertising value-ad: promoting sales, specials, auctions, limited quantities, etc. by inserting real-time, near-time, local or otherwise targeted information into the Primary Content stream

Online Auction/Shopping: an online auction/shopping channel in which viewers bid on the items presented, and the Digital Donut generates live graphics for broadcast on the channel based on an Internet (or other) server that implements the auction/shopping database.

Insertion of contextually related content into a Primary Content stream (ie: shopping opportunities based on Primary Content programming, additional information related to Primary Content, etc.)

Localization of content (ie: regional car ad with insertion of local dealership information)

Live web cam inserts into news, traffic, nature documentaries, travel shows, etc.

Live satellite image inserts into local news, weather, “cops”-style shows, etc.

Live data visualization using the Donut rendering engine to present up-to-the minute statistical data in a broadcast show (ie: high-end 3D graphic representations of polls, weather data, etc.)

Live VR broadcast that provides a custom, live view into a multiplayer VR world, video game, simulation, etc.

Live chat or news group feeds where participants in chat are all watching the same Primary Content, interactively.

The present invention has been described with reference to the above-detailed description. It is to be appreciated that other embodiment fulfill the spirit and scope of

1. A system for broadcast program signal application comprising:
means for monitoring a broadcast signal to obtain data insertion information therefrom;
means for generating a data stream for insertion into the broadcast signal; and,
means for inserting the data stream into the broadcast signal in real time to generate a single output signal for broadcast transmission.

2. A system for broadcast program signal application in accordance with claim 1, further comprising:
means for selecting data from a data source; and,
means for automatically generating the data stream for insertion into the broadcast signal based upon pre-established templates comprised of decision lists to edit the data selected.

3. A system for broadcast program signal application in accordance with claim 2 further comprising:
character generation means capable of inserting data from the data source into the pre-established templates.

4. A method for inserting data into a broadcast program signal comprising the steps of:
monitoring a broadcast signal to obtain data insertion information therefrom;
generating a data stream for insertion into the broadcast signal; and,
inserting the data stream into the broadcast signal in real time to generate a single output signal for broadcast transmission.

5. A method in accordance with claim 5 comprising the further steps of:
selecting data from a data source; and,
automatically generating the data stream for insertion into the broadcast signal based upon pre-established templates comprised of decision lists to edit the data selected.
